(19) United States
(12) Patent Application Publication
(10) Pub. No.: US 2019/0382578 A1
(43) Pub. Date: Dec. 19, 2019

(54) FLUORINE-CONTAINING ADDITIVES FOR NON-FLUORO THERMOPLASTIC POLYMERS

(71) Applicant: GM GLOBAL TECHNOLOGY OPERATIONS LLC, Detroit, MI (US)

(72) Inventors: April R. RODRIGUEZ, Santa Monica, CA (US); Adam F. GROSS, Santa Monica, CA (US); Ashley M. DUSTIN, Los Angeles, CA (US); Nancy L. JOHNSON, Northville, MI (US); Anthony L. SMITH, Troy, MI (US)

(21) Appl. No.: 16/011,176

(22) Filed: Jun. 18, 2018

(51) Int. Cl. C08L 55/02; C08L 25/06; C08L 69/00; C08J 3/20

(52) U.S. Cl. CPC C08L 55/02; C08L 25/06; C08L 69/00; C08J 3/201; C08J 2375/04; C08J 2355/02; C08J 2325/06; C08J 2369/00; C08L 2205/08

(57) ABSTRACT

An oleophobic composition contains a carbon-fluorine bond containing additive and a thermoplastic polymer. The additive contains sufficient solubilizing segments to compatibilize the bulk thermoplastic and additive, providing debris-phobic molded articles prepared from the composition.

### INTRODUCTION

This section provides background information related to the present disclosure which is not necessarily prior art.

The present disclosure relates to carbon-fluorine bond containing additives for non-fluorine containing thermoplastic polymers. Interior parts of automotive vehicles are increasingly being made from thermoplastic polymers, and these contribute to the aesthetic look of the vehicle as well as to weight reduction and ease of manufacturing. The parts are subject to fouling and contamination from the environment during every day use.

If possible, it would be desirable to formulate such thermoplastic interior parts to be self-cleaning or “debris-phobic.” However, the same properties that make an additive effective for cleanability tend to render compositions containing the additive unstable and unsuitable for molding. There have been workarounds, but none are completely acceptable. For example, spraying a topcoat on thermoplastic parts not only adds a processing step, but increases the chances of altering the look and feel of the final plastic part. Additionally, a coating on the surface of a plastic part increases the possibility that the coating can be removed or damaged caused by scratching and rubbing. Compatible additives for improving cleanability of plastic parts remain a challenge.

### SUMMARY

This section provides a general summary of the disclosure, and is not a comprehensive disclosure of its full scope or all of its features.

Compositions and molded articles made from the compositions are provided. The compositions and molded articles contain a thermoplastic polymer and an additive. The additive is a fluorinated polyurethane (or polyurea) having a non-fluorine containing so-called solubilizing segment that compatibilizes the additive and the thermoplastic polymer. In various embodiments, the thermoplastic polymer is selected from polystyrene, polycarbonate, polyacrylonitrile, polyamides, acrylonitrile butadiene styrene (ABS), styrene butadiene styrene (SBS), polyesters, polybutadiene, and thermoplastic olefins (TPO). The compositions and molded articles comprise a minor amount of the additive such as, without limitations, 0.01% to 15% by weight of the molded article or composition.

In various embodiments, the solubilizing segment of the additive comprises a non-fluorinated polyether segment, a non-fluorinated polyester segment, a non-fluorinated polyacrylate segment, a non-fluorinated polycarbonate, a non-fluorinated polybutadiene segment, or a non-fluorinated polyolefin.

In various embodiments, the molded articles of the current teachings are made of a copolymer of a polyisocyanate and a fluoropolymer, wherein the fluoropolymer is hydroxyl-terminated or amino-terminated and has a molecular weight of 500 g/mol to 20,000 g/mol. In a non-limiting example, the fluoropolymer has a general structure represented by PEG-PFPE-PEG, where PEG is a solubilizing segment comprising polyethylene glycol and wherein PFPE is a perfluorinated polyether block. In non-limiting fashion, the PFPE block can comprise repeat units of —CF₂CF₂O— or of —CF₂O—, or of both. An exemplary fluoropolymer is present in the triblock structure (I)

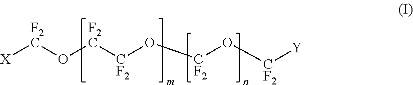

wherein X and Y are independently —CH₂—(O—CH₂—CH₂)ₚ-T, p is 1 to 50; T is a hydroxyl or amino terminal group; m is 1 to 100; and n is 1 to 100. In various embodiments, p is 4 or greater.

In various embodiments, one or both of the thermoplastic polymer and additive are soluble in an organic solvent. Non-limiting examples of potential solvents for the thermoplastic polymer and the additive include tetrahydrofuran, toluene, xylene, methyl ethyl ketone, acetone, methyl isobutyl ketone, butyl acetate, and dimethyl formamide.

Molded articles described in the current teachings can be made by melt extruding or injection molding compositions containing the thermoplastic polymer and the additive.

In certain variations, the fluorinated polyurethane includes from 0.1% up to 20% by weight of the solubilizing segment.

In other variations, the molded article is an interior plastic located in an automobile.

In various embodiments, the current teachings provide a composition comprising a thermoplastic polymer and a copolymer composition wherein the copolymer composition is a fluorinated polyurethane or polyurea composition. In particular, the copolymer composition can contain a reaction product of (a) fluoropolymer having an average molecular weight from about 500 g/mol to about 20,000 g/mol, wherein the fluoropolymer is (alpha, omega)-hydroxyl-terminated or (alpha, omega)-amino-terminated, and wherein the fluoropolymer is present in the triblock structure:

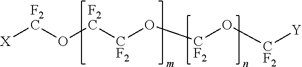

wherein X and Y are independently —CH₂—(O—CH₂—CH₂)ₚ-T, p is 1 to 50; T is a hydroxyl or amino terminal group; m is 1 to 100; and n is 1 to 100; (b) one or more isocyanate species, possessing an isocyanate functionality of 2 or greater; and (c) one or more polyol or polyamine chain extenders, or a reacted form thereof.

In these and other compositions, the thermoplastic polymer is selected from polystyrene, polycarbonate, polyacrylonitrile, polyamides, acrylonitrile butadiene styrene (ABS), styrene butadiene styrene (SBS), polyesters, polybutadiene, and thermoplastic polyolefins (TPO). More commonly used thermoplastic polymers include polycarbonates, polystyrene, and ABS. In various embodiments, the variable p in the triblock structure above is 1.5 or greater or is 4 or greater.

In another embodiment, a composition comprises a thermoplastic polymer and a copolymer, wherein the copolymer is the reaction product of (a) a fluoropolymer having an average molecular weight from about 500 g/mol to about 10,000 g/mol, wherein the fluoropolymer is (alpha, omega)-hydroxyl-terminated or (alpha, omega)-amino-terminated, and wherein the fluoropolymer is present in the triblock structure:

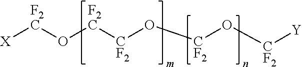

wherein X and Y are independently —CH₂—(O—CH₂—CH₂)ₚ-T, p is 1 to 50; T is a hydroxyl or amino terminal group; m is 1 to 100; and n is 1 to 100; (b) a second component selected from polyesters, polyethers, and polybutadienes, wherein the polyesters or polyethers or polybutadienes are (alpha, omega)-hydroxyl-terminated or (alpha, omega)-amino-terminated; (c) one or more isocyanate species, or a reacted form thereof, possessing an isocyanate functionality of 2 or greater; and (d) one or more polyol or polyamine chain extenders, or a reacted form thereof.

Non-limiting examples of thermoplastic polymers are the same as given above for the other compositions described herein.

Further areas of applicability will become apparent from the description provided herein. The description and specific examples in this summary are intended for purposes of illustration only and are not intended to limit the scope of the present disclosure.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to various preferred embodiments.

### Compositions

In various embodiments, a material composition contains one or more carbon-fluorine bond-containing additives (these are equivalently called as fluorine-containing or, in chemist shorthand, fluoro-containing) and one or more thermoplastic polymers, for example where the material comprises 0.01 to 50 wt. % of the fluoro-containing additive.

In certain embodiments, the carbon-fluorine bond-containing additive is a polyurethane or polyurea, for example one containing 1-20 wt. % fluoropolymer solubilizing groups or segments. The solubilizing groups are less highly fluorinated than the other parts of the additive, and examples include ethylene glycol, 2,2-bis(hydroxymethyl)propionic acid (and polymers thereof), polyethylene glycol, and polytetrahydrofuran.

The polyurethane or polyurea contain fluorinated chain segments that are partially or perfluorinated. Examples include poly(tetrafluoroethylene), polyvinylidene fluoride, or perfluoropolyethers, in non-limiting fashion.

In certain embodiments, the polyurethane or polyurea additive contains: a) one or more soft segments selected from ethoxylated fluoropolymers having an average molecular weight from about 500 g/mol to 10,000 g/mol, wherein said the polymer are hydroxyl-terminated and/or amine-terminated, and wherein said fluoropolymers are present in a triblock structure (I) (below), wherein:

X, Y═CH₂(OCH₂CH₂)ₚ-T, and X and Y are independently selected;

p=1 to 50;

T=a hydroxyl or amine terminal group

m=1-100; and

n=1 to 100;

b) one or more isocyanate species possessing an average isocyanate functionality of 2, or a reacted form thereof; and

c) one or more polyol or polyamine chain extenders or crosslinkers possessing an average functionality of 2, or a reacted form thereof.

The additives are processable at temperatures above 100° C. or above 125° C., in certain embodiments. The thermoplastic polymer is one that is melt processable and/or soluble in common solvents with the additive. The additive contains solubilizing segments of such a size that the additive and the thermoplastic are compatible in solvent processing and in melt processing.

The thermoplastic polymer in various embodiments can be selected from polyolefins (polyethylene, polypropylene, polyisoprene); polyacrylonitrile; polybutadienes; polystyrene; polycarbonates; ABS block polymers; SBS block polymers; polylactic acid; and polyesters such as PET.

Methods of combining one or more additives and one or more thermoplastic polymers include those wherein:

1) all components are dissolved in a solvent;

2) one or more components are dissolved and one or more other components remain unadulterated;

3) all components are taken above their respective melting temperatures; or

4) one or more components are taken above their respective melting temperatures and one or more other components are below their respective melting temperatures.

A method of molding a thermoplastic part that contains the thermoplastic and the additive involves making the temperature of the mold equal to or higher than the melting temperature of the thermoplastic and/or the thermoplastic carbon-fluorine bond containing-additive mixture; and optionally coating the mold with a compatibilizing element.

### Molded Articles

The current teachings provide methods of incorporating antifouling properties to common thermoplastics in order to produce durable soil preventative material. Examples are given of the use of such molded articles and compositions for use in providing various molded articles in the interior of vehicles. In an aspect, the teachings represent an improvement over conventional compositions and molded articles, which have generally relied on spraying a topcoat on some plastic parts in order to make the parts easier to clean. The phrase used in the industry is how to provide “debris-phobic” technology on finished parts. Spraying a topcoat on thermoplastic parts not only adds a processing step, but increases the chances of altering the look and feel of the final plastic part. Additionally, a highly fluorinated coating on the surface of a plastic part increases the possibility that the coating can be removed or damaged from scratching and rubbing.

Thermoplastic polymers are therefore to be modified with various additives, wherein the thermoplastic polymers include but are not limited to polystyrene, polycarbonate, ABS, and TPO. Molded articles made of these and other thermoplastic polymers are surface modified for use in automobile interiors to increase both stain resistance and cleanability. The technology can be used, in non-limiting fashion, on interior plastics located on or in the air bag emblem, cup holders, glove box, console, assist handles, non-metal trim, door trim panel, HVAC outlet trim, door sill plate, and dashboards.

In compositions of the current teachings, the thermoplastic makes up 50% by weight or more of the composition of the molded article. The additive is included in the compositions and molded articles in an amount sufficient to provide the desired cleanability or hydrophobicity of the surface of the molded articles. Generally, the additive is present at a level of 0.01% by weight to about 25% by weight, 0.01 to 20% by weight, or 0.01 weight percent to 15 weight percent. In various embodiments, the additive is provided at a level of 0.1% or greater, 0.2% or greater, or 0.5% or greater, or at 1% by weight or greater of the weight of the total composition or molded article.

### Fluorinated Polyurethane Additive

The additive is a polyurethane or polyurea compound that contains fluorinated groups or perfluorinated groups in its backbone. As such, the additive is described as a reaction product, or equivalently a copolymer, of an isocyanate species and a fluoropolymer species. The isocyanate species can be selected from aromatic isocyanates such as toluene diisocyanate (TDI) and methylene diphenyl isocyanate (MDI), as well as aliphatic isocyanates such as hexane diisocyanate (HDI) and methylene dicyclohexyl diisocyanate (HMDI). Although the additive is commonly referred to as the reaction product of an isocyanate species and a fluoropolymer, as further described herein, it is understood that the starting material for making the copolymer can also be selected from isocyanates modified with a blocking agent, such as one that is released once the polyisocyanate species is raised above a deblocking temperature. These modifications to the polymeric starting materials are referred to as a reacted form of the polyisocyanate.

In various embodiments, the additive is a reaction product of polyisocyanate, advantageously one possessing an isocyanate functionality of 2 or greater, with a fluoropolymer and other polyols or polyamines that react with the diisocyanate to make the polyurethane or polyurea, respectively. In exemplary fashion, a fluoropolymer is selected to react with the isocyanate or reacted form thereof to make a fluorinated polyisocyanate.

In one embodiment, the fluoropolymer is represented by a formula A-B-A, wherein B represents a fluorinated or perfluorinated block of polyether, and A represents a non-fluorinated polyether section or segment containing a solubilizing group. In non-limiting fashion, B contains polytetrafluoroethylene.

In other embodiments A is independently selected from ethylene glycol, polyethylene glycol, polytetrahydrofuran, and 2,2-bis(hydroxymethyl) propionic acid An example of such block polymer is given in the formula PEG-PFPE-PEG, wherein PEG represents blocks of polyethylene glycol (which is unfluorinated) and wherein PFPE is a perfluorinated polyether block. Examples of these block fluoropolymers are given in non-limiting fashion in formula (I) described above.

In one embodiment, a suitable additive is selected from those described in U.S. 2016/0194574, the disclosure of which is incorporated by reference. In this embodiment, the additive comprises:

(a) one or more first soft segments selected from fluoropolymers having an average molecular weight from about 500 g/mol to about 10,000 g/mol, wherein the fluoropolymers are (α, ω)-hydroxyl-terminated and/or (α, ω)-amine-terminated;

(b) one or more second soft segments selected from polyesters or polyethers, wherein the polyesters or polyethers are (α, ω)-hydroxyl-terminated and/or (α, ω)-amine-terminated;

(c) one or more isocyanate species, or a reacted form thereof, possessing an isocyanate functionality of 2 or greater; and

(d) one or more polyol or polyamine chain extenders or crosslinkers, or a reacted form thereof, wherein the molar ratio of the second soft segments to the first soft segments is less than 2.0.

In some embodiments, the molar ratio of the second soft segments to the first soft segments is from about 0.1 to about 1.5.

In certain embodiments, the fluoropolymers include a fluoropolymer having the structure:

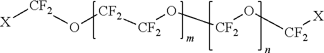

wherein:

X═CH₂—(CH₂—CH₂—O)ₚ—OH wherein p=1 to 50;

m=1 to 100; and

n=1 to 100.

In some embodiments, the polyesters or polyethers are selected from the group consisting of poly(oxymethylene), poly(ethylene glycol), poly(propylene glycol) (also known as poly(propylene oxide)), poly(tetrahydrofuran) (also known as poly(tetramethylene oxide)), poly(glycolic acid), poly(caprolactone), poly(ethylene adipate), poly(hydroxybutyrate), poly(hydroxyalkanoate), and combinations thereof.

In some embodiments, the isocyanate species is selected from the group consisting of 4,4′-methylenebis(cyclohexyl isocyanate), hexamethylene diisocyanate, cycloalkyl-based diisocyanates, tolylene-2,4-diisocyanate, 4,4′-methylenebis(phenyl isocyanate), isophorone diisocyanate, and combinations or derivatives thereof.

The polyol or polyamine chain extender or crosslinker possesses a functionality of 2 or greater, in some embodiments. At least one polyol or polyamine chain extender or crosslinker may be selected from the group consisting of 1,3-butanediol; 1,4-butanediol; 1,3-propanediol; 1,2-ethanediol; diethylene glycol; triethylene glycol; tetraethylene glycol; propylene glycol, dipropylene glycol, tripropylene glycol, neopentyl glycol; 1,6-hexanediol; 1,4-cyclohexanedimethanol; ethanolamine; diethanolamine; methyldiethanolamine, phenyldiethanolamine, glycerol, trimethylolpropane; 1,2,6-hexanetriol; triethanolamine, pentaerythritol, ethylenediamine; 1,3-propanediamine; 1,4-butanediamine; diethyltoluenediamine, dimethylthiotoluenediamine, isophoronediamine, diaminocyclohexane, N,N,N′,N′-tetrakis(2-hydroxypropyl)ethylenediamine, and homologues, derivatives, or combinations thereof.

In another, the additive is selected from those described in US 2016/0201005, the disclosure of which is incorporated by reference. In various embodiments, the additive is a copolymer composition containing hard and soft segments and prepared as the reaction product of:

(a) fluoropolymers having an average molecular weight from about 500 g/mol to about 20,000 g/mol, wherein the fluoropolymers are (α, ω)-hydroxyl-terminated and/or (α, ω)-amine-terminated, and wherein the fluoropolymers are present in the triblock structure:

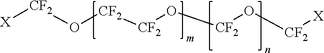

wherein:

X, Y═CH₂—(O—CH₂—CH₂)ₚ-T, and X and Y are independently selected;

p=1 to 50;

T is a hydroxyl or amine terminal group;

m=1 to 100; and

n=1 to 100;

(b) one or more isocyanate species possessing an average isocyanate functionality of about 2 or greater, or a reacted form thereof; and

(c) one or more polyol or polyamine chain extenders or crosslinkers possessing an average functionality of about 3 or greater, or a reacted form thereof.

In some embodiments, the fluoropolymers have an average molecular weight from about 1,000 g/mol to about 10,000 g/mol.

In the formulas given above, X and Y may be the same or different. That is, the end groups X and Y may differ in terminal groups, in the value of the variable p, or in both. Generally, the values of p, m and n are selected such that the molecular weight of the non-fluorinated portion (i.e. the one providing the solubilizing segment) of the additive is from about 1 to about 20 percent by weight of the total additive. Suitable commercial materials meeting the structure recited in the formulas above are available from Solvay Specialty Polymers under the Fluorolink® trade name.

When the terminal groups X and Y in the formulas above are hydroxyl, the copolymer composition made by reacting with the polyisocyanate species is considered to be a polyurethane. On the other hand, when the terminal groups are an amino group, the polymeric material formed by reaction with polyisocyanate is considered to be a polyurea. Both polyurethanes and polyureas, as here described, are considered to be suitable additives for preparing the compositions and molded articles of the current teachings.

As noted, the non-fluorinated sections of the polyureas and polyurethanes described herein are recognized to be a solubilizing segment, imparting solubility in various common organic solvents, and/or compatibility of the additive with the thermoplastic polymers in the molded articles. In practice it is desirable to make the solubilizing segment of the additive large enough to have a solubilizing effect, but not so large that the cleanability or debris-phobic nature of the additive is lost. Suitable levels of solubilizing agent in the various fluoropolymers can be determined empirically. As a rule of thumb, a solubilizing segment of approximately 1% to 20% by weight of the total weight of the additive has been found acceptable. Further non-limiting examples and teachings are given in the examples section below.

### Making the Compositions

Once the fluorinated polyurethane/polyurea additive is provided that contains sufficient solubilizing groups/segments as discussed herein, compositions containing the additive and the thermoplastic can be made by solution processing or by melt processing. In both methods, advantage is taken of the effect of the solubilizing group in the additive to increase the compatibility between the additive and the thermoplastic.

In solution processing, the thermoplastic and debris-phobic polyurethane/polyurea can be dissolved separately in a common solvent, or can be dissolved together in a common solvent. It is also possible to use one solvent for the thermoplastic and another solvent for the additive, although it is usually more practical to use a common solvent for both. If the thermoplastic and the additive are to be dissolved separately in a common solvent, the additive solution and the thermoplastic solution are combined at the desired loading concentration. The result is a solution containing the solvent and both the additive and the thermoplastic.

The solution can then be drop cast, sprayed, etc. to allow the solvent to evaporate, which forms a freestanding film or block of modified thermoplastic (i.e., containing the additive) with low surface energy properties. The freestanding film or block can then be ground to provide pellets of a composition containing both the additive and the thermoplastic. In another method, a free standing film of the additive alone is provided, which is ground to provide particles of the additive to be blended with pellets/particles of the thermoplastic.

In melt processing, pellets of the thermoplastic are combined with the additive and the materials are melted together at a suitable temperature in order to blend and form uniform mixtures. After mixing, the blend is removed from the heat and solidified to form a modified thermoplastic containing the additive. Alternatively or in addition, the polymer materials (i.e., the additive and the thermoplastic) can be combined, for example by grinding or by ball milling, prior to melt processing. As before, the product of the melt processing is a homogeneous film or other composition that can then be broken down into a powder that can be melted to form the molded objects. Solvents to be used for the solution processing include any that dissolve the additive and the thermoplastic at suitable levels. Examples include tetrahydrofuran (THF) and methyl ethyl ketone (MEK). Other non-limiting examples of solvents include toluene, xylene, acetone, methyl isobutyl ketone, and dimethyl formamide.

Before injection molding, other additives can be combined with the uniform mixture of additives and thermoplastics. For example, antioxidants can be added to minimize or terminate oxidation caused by ultraviolet or by heating. Hindered amines stabilizers can be used to counter light induced degradation. If desired, the polyisocyanates in the additive can comprise phenyl groups to increase thermal stability. Other optional ingredients include fillers, pigments, dyes, plasticizers, flame retardants, flattening agents, and adhesion promoters. If used, the particulate fillers may be selected from silica, alumina, silicates, talc, aluminosilicates, barium sulfate, mica, diatomite, calcium carbonate, calcium sulfate, carbon, and wollastonite, in non-limiting fashion. Combinations of fillers can also be used. The filler is optionally surface modified, for example with fatty acids, silanes, alkylsilanes, fluoroalkylsilanes, silicones, alkyl phosphonates, alkyl phosphonic acids, alkyl carboxylates, alkyldisilazanes, and the like.

Compositions containing both the additive and the thermoplastic, as well as other components if present, can then be melt extruded or injection molded to provide molded articles as described herein.

### Measurements of Oleophobicity

Suitability of potential polymeric mixtures containing the additive and thermoplastic for debris-phobic applications is conveniently assessed using measurements of contact angle between the mixture surface and an oil like hexadecane. In this test, a higher contact angle with hexadecane indicates a higher degree of oleophobicity. An oleophobic surface tends to repel oil, making the surface resistant to soiling in the first place and easier to clean should it become soiled. Sessile drops are conveniently measured, and are reported in the Examples that follow.

In general, the effectiveness of an additive is considered positive if its presence formulated into the polymeric compositions results in a higher contact angle (measured using an oil like hexadecane) than a composition without the additive or with the additive at a lower level. And the effect is more favorable the greater the observed increase in contact angle. Likewise, contact angle measurements can indicate whether a level of solubilizing group in a fluoropolymer is sufficient to increase the compatibility of the thermoplastic and additive.

In various embodiments, compositions and molded articles from the compositions also reflect an increase in the contact angle of water on the composition or molded article. An increase in the water contact angle is also to be taken as a sign of effectiveness of the parameter being tested (e.g. the amount of solubilizing group in the additive, or the amount of additive in the composition or molded article.

The current teachings have been set forth with respect to various preferred embodiments. Further non-limiting examples of the technology is given in the examples that follow.

### EXAMPLES

### Materials

4, 4′-Methylenebis (cyclohexyl isocyanate) (HMDI), 1, 4-Butanediol (BD), Dibutyltin dilaurate (DBTDL) were purchased from Aldrich. Fluorolink 4000, E10-H, 5147x and 5158x purchased from Solvay Specialty Polymers. Thermoplastics: polycarbonate (MW 45,000) purchased from Acros organics, polystyrene (MW 192,000) purchased from Aldrich, and Acrylonitrile butadiene styrene (ABS; 75% polybutadiene) pellets and powder (Galata Chemicals).

### Example 1: BPT100 Thermoplastic Synthesis, 16% Solubilizing Material

Fluorolink 5147x (2.9 mmoles, 7 g) and HMDI (14.5 mmoles, 3.8 g) were added into a 3-neck flask equipped with mechanical stirrer. The reaction flask was placed in a 100° C. oil bath and allowed to stir for 10 minutes before the addition of 2.2 μl of DBTDL. The reaction mixture was stirred at 100° C. for 1 hour. The reaction flask was then removed from heat and allowed to cool down before the addition of 2-butanone (MEK, 9 mL). In a vial BD (11.6 mmoles, 1.0 g) was dispersed in solvent mixture (MEK, 3 mL; Acetone, 4.3 mL; Xylene 2.5 mL). The prepolymer solution and curative were combined and mixed with a speed mixer (2300 rpm, 30 seconds). The sample was sprayed with an HVLP gun using 0.6 mm nozzle aperture to a thickness of 5 mils.

### Example 2: BPT300 Thermoplastic Synthesis, 4% Solubilizing Material

Fluorolink E10-H (5.1 mmoles, 10 g) and HMDI (20.2 mmoles, 5.3 g) were added into a 3-neck flask equipped with mechanical stirrer. The reaction flask was placed in a 100° C. oil bath and allowed to stir for 10 minutes before the addition of 3.1 μl of DBTDL. The reaction mixture was stirred at 100° C. for 1 hour. The reaction flask was then removed from heat and allowed to cool down before the addition of 2-butanone (MEK, 13 mL). In a vial BD (15.5 mmoles, 1.4 g) was dispersed in solvent mixture (MEK, 4.2 mL; Acetone, 6.0 mL; Xylene 3.5 mL). The prepolymer solution and curative were combined and mixed with a speed mixer (2300 rpm, 30 seconds). The sample was sprayed with an HVLP gun using 0.6 mm nozzle aperture to a thickness of 5 mils.

### Comparative Example 1: BPT400 Thermoplastic Synthesis, 0% Solubilizing Material

Fluorolink D4000 (2.5 mmoles, 10 g) and HMDI (19.8 mmoles, 5.2 g) were added into a 3-neck flask equipped with mechanical stirrer. The reaction flask was placed in a 100° C. oil bath and allowed to stir for 10 minutes before the addition of 3.2 μl of DBTDL. The reaction mixture was stirred at 100° C. for 1 hour. The reaction flask was then removed from heat and allowed to cool down before the addition of 2-butanone (MEK, 13 mL). In a vial BD (17.8 mmoles, 1.6 g) was dispersed in solvent mixture (MEK, 4.8 mL; Acetone, 6.9 mL; Xylene 4 mL). The prepolymer solution and curative were combined and mixed with a speed mixer (2300 rpm, 30 seconds). The sample was sprayed with an HVLP gun using 0.6 mm nozzle aperture to a thickness of 5 mils.

TABLE 1
Polymer examples and comparative example with similar
hard segment % with decreasing solubilizing material %

| Example | Hard Segment wt. % | Fluoro wt. % | Solubilizer wt. % |
|---|---|---|---|
| Example 1 | 41% | 43% | 16% |
| Example 2 | 40% | 56% | 4% |
| Comparative | 41% | 59% | 0% |
| Example | | | |

### Example 3 and 4: Solution Preparation of Hygroscopic-Fluorinated Thermoplastic Polyurethane

BPT100 (or BPT300) was dissolved by stirring in tetrahydrofuran (THF) to a final concentration of 1 to 10% by weight.

Comparative Example Solution Preparation of fluorinated thermoplastic polyurethane. BPT400 has no solubilizing components, which prevents solubility in tetrahydrofuran.

### Thermoplastics Solution Preparation

Prepared thermoplastic solutions by dissolving the thermoplastics polymers in tetrahydrofuran (THF) for easy incorporation of the BPT100 or BPT300 additive. Other solvents can be used, but THF is preferred due to BPT technology solubility in THF. The solutions prepared were:

Polycarbonate 10 wt. %

Polystyrene 10 wt. %

ABS pellet 24 wt. %

ABS powder 8 wt. %

### Example 5: Solvent Casted ABS Thermoplastic Film with 5% Example 1 Additive

BPT100 solution was diluted to 2.2% by weight with more THF to minimize error with small volume additions. The 24% ABS solution (0.5 g solution, 0.12 g ABS) was weighed into a disposable FlackTek speed mixing cup. To this solution the 2.2% BPT100 solution was added (0.23 g solution, 5 mg BPT100). This solution was mixed in a FlackTek centrifugal speed mixer for 30 seconds at 2300 rpm. The mixture was then drop casted on silane modified Mylar® and using a drawdown bar the solution was drawn out to give an even thickness film 2 to 4 mil. The solvent was allowed to evaporate and the sample can be covered to slow evaporation of solvent to minimize and prevent bubble formation.

### Example 6: ABS Thermoplastic Melt Blended with BPT100

For proof of concept, pellets of ABS (0.5 g) were weighed onto a Pyrex dish. The dish was placed on a hot plate that was set to 220° C. The pellets began to soften and adhere together. Once the ABS was spreadable with a spatula, BPT100 (0.026 g) films were placed on the hot softened ABS. The BPT100 quickly melted and was blended into the ABS using the spatula. The polymer mass was spread into a thin film multiple times to insure homogenous mixing of BPT100 in ABS. The polymer mass was removed from heat and quickly placed between glass slides with a heavy weight on the top slide to make a thin flat film for measuring contact angle.

### Example 7: Contact Angle Measurements

To determine the wettability of treated and untreated thermoplastics, contact angles were measured. The water contact angle was measured by placing a 25 μL droplet of deionized water on the surface and measuring the angle with a goniometer. Modification of the thermoplastics using the solvent solution strategy showed increases in the water contact angle for all 3 plastics with 5 and 10% BPT100. Table 2 shows increases from low 70s-high 80s to low 90s-100. Contact angle measurements were also taken using hexadecane as a generic oil. All three unmodified thermoplastics had contact angles that were <10 degrees and hard to accurately measure with the goniometer due to spreading of the oil droplet. Upon addition of 5 and 10% BPT-100, a significant increase in contact angle was seen with measurements from 25 degrees up to low 70s. Increases in contact angle measurements can be seen with the melt procedure for ABS modification, but were not as pronounced as the solution strategy. The solution strategy allows better homogenization due to the ability to fully dissolve each material before combining them.

TABLE 2
Contact angles of untreated and treated thermoplastics with 5
and 10% BPT100 using both the solution strategy.

| | Untreated | | 5% Example 1 | | 10% Example 1 | |
|---|---|---|---|---|---|---|
| Material | H₂O | Hexadecane | H₂O | Hexadecane | H₂O | Hexadecane |
| Polystyrene (PS) | 87 | <10 | 100 | 25 | — | — |
| Acrylonitrile | 73 | <10 | 92 | 51 | 100 | 63 |
| butadiene styrene | | | | | | |
| (ABS) | | | | | | |
| Polycarbonate (PC) | 88 | <10 | 107 | 46 | 90 | 74 |

TABLE 3
Contact angles of untreated and treated thermoplastics using
melt processing strategy.

| | Water Contact | Hexadecane Contact |
|---|---|---|
| Material | Angle | Angle |
| ABS | 81 | 15 |
| ABS + 5% Example 1 | 96 | 54 |
| ABS + 10% Example 1 | 97 | 48 |
| ABS + 10% Example 2 | 108 | 54 |

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A molded article comprising a thermoplastic polymer and an additive, wherein the additive is a fluorinated polyurethane with a non-fluorine containing solubilizing segment that compatibilizes the thermoplastic polymer and the additive.

2. The composition according to claim 1, wherein the thermoplastic polymer comprises a material selected from polystyrene, polycarbonate, polyacrylonitrile, polyamides, acrylonitrile butadiene styrene (ABS), styrene butadiene styrene (SBS), polyesters, polybutadiene, and thermoplastic olefins (TPO).

3. The molded article according to claim 1, comprising 0.01 to 15% by weight of the additive.

4. The molded article according to claim 1, wherein the solubilizing segment comprises non-fluorinated polyether, non-fluorinated polyester, non-fluorinated polyacrylate, non-fluorinated polycarbonate, non-fluorinated polybutadiene, or non-fluorinated polyolefin.

5. The molded article according to claim 1, wherein the additive is a copolymer of a diisocyanate and a fluoropolymer, wherein the fluoropolymer is hydroxyl-terminated or amino-terminated and has a molecular weight of 500 g/mol to 20,000 g/mol.

6. The molded article according to claim 5, wherein the fluoropolymer has a general structure represented by PEG-PFPE-PEG, where PEG is a solubilizing segment comprising polyethylene glycol and PFPE is a perfluorinated polyether block.

7. The molded article according to claim 6, wherein the PFPE block comprises repeat units of —CF₂CF₂O— or of —CF₂O—

8. The molded article according to claim 7, wherein the fluoropolymer is present in the triblock structure (I) 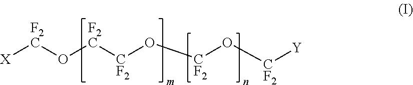
wherein:
X and Y are independently —CH₂—(O—CH₂—CH₂)ₚ-T, p is 1 to 50; T is a hydroxyl or amino terminal group; m is 1 to 100; and n is 1 to 100.

9. The molded article according to claim 8, wherein p is 4 or greater.

10. The molded article according to claim 1, wherein the thermoplastic polymer and the additive are soluble in an organic solvent selected from tetrahydrofuran, toluene, xylene, methyl ethyl ketone, acetone, methyl isobutyl ketone, butyl acetate, and dimethyl formamide.

11. The molded article according to claim 5, wherein the fluorinated polyurethane comprises from 0.1% up to 20% by weight of the solubilizing segment.

12. The molded article of claim 1, which is an interior plastic located in an automobile.

13. A method of making the molded article of claim 1, comprising melt extruding a composition comprising the thermoplastic polymer and the additive.

14. A composition comprising a thermoplastic polymer and a copolymer composition, wherein the copolymer composition is the reaction product of
(a) fluoropolymer having an average molecular weight from about 500 g/mol to about 20,000 g/mol, wherein the fluoropolymer is (alpha, omega)-hydroxyl-terminated or (alpha, omega)-amino-terminated, and wherein the fluoropolymer is present in the triblock structure: 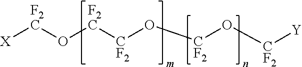
wherein:
X and Y are independently —CH₂—(O—CH₂—CH₂)ₚ-T, p is 1 to 50; T is a hydroxyl or amino terminal group; m is 1 to 100; and n is 1 to 100;
(b) one or more isocyanate species, possessing an isocyanate functionality of 2 or greater; and
(c) one or more polyol or polyamine chain extenders, or a reacted form thereof.

15. The composition according to claim 14, wherein the thermoplastic polymer is selected from polystyrene, polycarbonate, polyacrylonitrile, polyamides, acrylonitrile butadiene styrene (ABS), styrene butadiene styrene (SBS), polyesters, polybutadiene, and thermoplastic olefins (TPO).

16. The composition according to claim 15, wherein the thermoplastic polymer is polycarbonate, polystyrene, or ABS.

17. The composition according to claim 14, wherein p is 1.5 or greater.

18. The composition according to claim 14, wherein p is 4 or greater.

19. A composition comprising a thermoplastic polymer and a copolymer, wherein the copolymer is the reaction product of:
(a) a fluoropolymer having an average molecular weight from about 500 g/mol to about 10,000 g/mol, wherein the fluoropolymer is (alpha, omega)-hydroxyl-terminated or (alpha, omega)-amino-terminated, and wherein the fluoropolymer is present in the triblock structure: 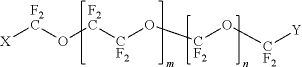
wherein:
X and Y are independently —CH₂—(O—CH₂—CH₂)ₚ-T, p is 1 to 50; T is a hydroxyl or amino terminal group; m is 1 to 100; and n is 1 to 100;
(b) a second component selected from polyesters, polyethers, and polybutadienes, wherein the polyesters or polyethers or polybutadienes are (alpha, omega)-hydroxyl-terminated or (alpha, omega)-amino-terminated;
(c) one or more isocyanate species, or a reacted form thereof, possessing an isocyanate functionality of 2 or greater; and
(d) one or more polyol or polyamine chain extenders, or a reacted form thereof; and
the thermoplastic polymer is selected from polystyrene, polycarbonate, polyacrylonitrile, polyamides, acrylonitrile butadiene styrene (ABS), styrene butadiene styrene (SBS), polyesters, polybutadiene, and thermoplastic olefins (TPO).

20. The composition according to claim 19, wherein the thermoplastic polymer is polycarbonate, polystyrene, or ABS.
